(19) United States
(12) Patent Application Publication
(10) Pub. No.: US 2019/0268387 A1
(43) Pub. Date: Aug. 29, 2019

(54) METHOD AND SYSTEM FOR EXPANDED PARTICIPATION IN A COLLABORATION SPACE

(71) Applicant: Avaya Inc., Santa Clara, CA (US)

(72) Inventors: Gregory Pelton, Raleigh, NC (US); Mohammad Nezarati, Richmond Hill (CA)

(21) Appl. No.: 16/283,476

(22) Filed: Feb. 22, 2019

Related U.S. Application Data
(60) Provisional application No. 62/636,649, filed on Feb. 28, 2018.

(51) Int. Cl. H04L 29/06

(52) U.S. Cl. CPC H04L 65/4015

(57) ABSTRACT

The methods and systems of the present disclosure can include a first collaboration space; a second collaboration space; and a third collaboration space; where the third collaboration space is created after the first collaboration space and the second collaboration space, where a first property from the first collaboration space and a second property from the second collaboration space is aggregated into the third collaboration space; and where existence of the third collaboration space is conditioned upon existence of at least one of the first collaboration space and the second collaboration space.

### FIELD

The disclosure relates generally to communications and particularly to expanded participation options for communication systems.

### BACKGROUND

There are various options in existence for group collaboration. For example, some online tools provide persistent team workspaces or channels for organizing discussions and work products. The spaces can be identified by subject, project, team, department, etc., and can also enable real-time communications between members of the workspace. However, there is a need for improved participation options in the presently existing collaboration solutions.

### SUMMARY

Existing collaboration solutions problematically only recognize people (e.g., human users (also referred to herein as “users”)) as participants, which limits the breadth of collaboration. In addition, existing collaboration solutions also do not facilitate collaboration between different workspaces. For example, there are many different vendors developing different workspaces for collaboration, and users can become fragmented thereby interfering with effective collaboration as people use different solutions (e.g., the various different spaces provided by different vendors). Thus, it would be advantageous to have methods and systems for expanded participation options for workspaces.

Various embodiments of the present disclosure provide collaboration solutions that recognize devices and other Internet of Things components, as well as people, as participants. In some aspects, devices may possess the same or similar attributes as other participants (e.g., users, parties, members, and people) to workspace (including the communication session), or may serve as proxies for other participants.

Various embodiments of the present disclosure provide an ability for different collaboration workspaces to resolve with one another in order to facilitate collaboration between the different spaces, even though the different spaces may have different properties, different members, domains, etc. In some aspects, the methods and systems disclosed herein provide integration options between spaces and allow the spaces to federate services and participants.

Some embodiments disclosed herein relate to systems, comprising: a first collaboration space having a first set of members, wherein a device that is not associated with any user is one member within the first set of members of the first collaboration space.

In some aspects, the systems can include a second collaboration space, wherein at least one piece of information is federated automatically from the first collaboration space to the second collaboration space. The at least one piece of information can be a network resource accessed via an application programming interface (API). The second collaboration space can have a second set of members, wherein a subset of members from the first set of members is added to the second collaboration space as added members, and wherein the added members are identified to the second set of members as proxy members. In various aspects, the first collaboration space has a first service, wherein the second collaboration space has a second set of members, wherein the first service is added to the second collaboration space as an added service, and wherein the added service is identified to the second set of members as a proxy service.

In some aspects the system can further comprise a second collaboration space; and a third collaboration space; wherein the third collaboration space is created after the first collaboration space and the second collaboration space, wherein a first property from the first collaboration space and a second property from the second collaboration space is aggregated into the third collaboration space; and wherein existence of the third collaboration space is conditioned upon existence of at least one of the first collaboration space and the second collaboration space. The system can further comprise a second set of members of a second collaboration space; and a third set of members of a third collaboration space, wherein the third set of members comprises at least some members from each of the first set of members and the second set of members, and wherein the third set of members collaborate within the third collaboration space. The first collaboration space, the second collaboration space, and the third collaboration space can each comprise a persistent and context-rich environment. In some aspects, the first property is at least one policy and wherein the second property is a different policy, and wherein a conflict between the at least one policy and the different policy is resolved using an automated arbitration process. In various aspects, the first property is a first element of content, the second property is a second element of content, and the first and the second element of content are presented in the third collaboration space.

Some embodiments disclosed herein relate to methods, comprising: establishing a first collaboration space having a first set of members, wherein a device that is not associated with any user is one member within the first set of members of the first collaboration space.

In some aspects, the methods further comprise establishing a second collaboration space, and federating at least one piece of information is automatically from the first collaboration space to the second collaboration space. The at least one piece of information can be a network resource accessed via an application programming interface (API). The second collaboration space can have a second set of members, and the methods can further comprise adding a subset of members from the first set of members is to the second collaboration space as added members, wherein the added members are identified to the second set of members as proxy members. In various aspects, the first collaboration space has a first service, the second collaboration space has a second set of members, and the methods further comprise adding the first service is to the second collaboration space as an added service, wherein the added service is identified to the second set of members as a proxy service.

In some aspects, the methods further comprise: establishing a second collaboration space; and establishing a third collaboration space; wherein the third collaboration space is established after the first collaboration space and the second collaboration space, wherein a first property from the first collaboration space and a second property from the second collaboration space is aggregated into the third collaboration space; and wherein existence of the third collaboration space is conditioned upon existence of at least one of the first collaboration space and the second collaboration space. The methods can further comprise: a second set of members of a second collaboration space; and a third set of members of a third collaboration space, herein the third set of members comprises at least some members from each of the first set of members and the second set of members, and wherein the third set of members collaborate within the third collaboration space. In various aspects, the first collaboration space, the second collaboration space, and the third collaboration space each comprise a persistent and context-rich environment. The first property can be at least one policy and wherein the second property can be a different policy, wherein a conflict between the at least one policy and the different policy is resolved using an automated arbitration process. The first property can be a first element of content, the second property can be a second element of content, and the first and the second element of content can be presented in the third collaboration space.

Some embodiments disclosed herein relate to systems, comprising: a first collaboration space; a second collaboration space; and a third collaboration space; wherein the third collaboration space is created after the first collaboration space and the second collaboration space, wherein a first property from the first collaboration space and a second property from the second collaboration space is aggregated into the third collaboration space; and wherein existence of the third collaboration space is conditioned upon existence of at least one of the first collaboration space and the second collaboration space.

In some aspects, the systems can also include a first set of members of the first collaboration space; a second set of members of the second collaboration space; and a third set of members of the third collaboration space, wherein the third set of members comprises at least some members from each of the first set of members and the second set of members, and wherein the third set of members collaborate within the third collaboration space. In some aspects, the first collaboration space, the second collaboration space, and the third collaboration space each comprise a persistent and context-rich environment. The first property can comprise at least one policy and the second property can comprise a different policy, and a conflict between the at least one policy and the different policy may be resolved using an automated arbitration process.

In various aspects, the first property can be a first element of content, the second property can be a second element of content, and the first element of content and the second element of content may be presented in the third collaboration space. The first element of content and the second element of content can comprise a shared document. At least one application accessible via the first collaboration space may be automatically accessible via the third collaboration space.

Some embodiments disclosed herein relate to methods, comprising: establishing a collaboration space by assigning a first network resource that provides a persistent record of information exchanged within the collaboration space and by assigning a second network resource that enables real-time communications between members of the collaboration space; providing a user with access to the first and the second network resource; and providing a device with access to the first and the second network resource.

In some aspects, the collaboration space can enable non-real-time collaboration with the real-time collaboration. For example, changes and comments to documents may be posted for later viewing, and the same or different documents may also be changed in real-time (e.g., other users may see changes happening in real-time). The methods can further comprise authenticating the user prior to allowing the user the access to the first and the second network resource, wherein the authenticating the user comprises comparing an identification information for the user with a list of invited users. The methods can further comprise authenticating the device prior to allowing the device the access to the first and the second network resource, wherein the authenticating the device comprises comparing an identification information for the device with a list of invited devices. The identification information for the device can comprise a reference to the identification for the user. The device may comprise at least one of a telecommunication endpoint, a smartphone, a conference phone, a video endpoint, a speaker, a microphone, and a camera, a sensor, an actuator, or a service like a bot or notification or relay service. The device can access at least one of the first and the second network resource via an application programming interface (API) (e.g., a software intermediary that allows two applications to communicate). The device may be provisioned as a member of the collaboration space by a creator or existing member of the collaboration space.

Some embodiments disclosed herein relate to methods, comprising: after creating a first collaboration space and a second collaboration space, creating a third collaboration space; aggregating a first property from the first collaboration space and a second property from the second collaboration space into the third collaboration space; and conditioning existence of the third collaboration space upon existence of at least one of the first collaboration space and the second collaboration space.

In some aspects, the methods can further comprise a first set of members of the first collaboration space; a second set of members of the second collaboration space; aggregating the first set of members with the second set of members; assigning the aggregated first and second set of members as joint members for the third collaboration space; and enabling the first and second set of members to collaborate with one another via the third collaboration space. The first property can be a first set of members including at least one device, wherein the at least one device is not associated with a user, and the second property can be a second set of members. The at least one device can access a network resource via an API from the third collaboration space.

Embodiments disclosed herein are advantageous for many reasons. One reason is because they provide unique options for expanded uses of collaboration spaces. Illustrative options provided herein include the ability to have devices as participants of collaboration spaces. Devices do not need to be associated with any user. The ability to include devices as participants expands the functionality achieved by collaboration spaces, for example by providing new and improved automated functions. Thus, devices may be considered to be a participant of one or more workspaces/spaces, and devices may also be considered to be a user and/or member, as described herein. The expanded uses provide various integration options between spaces. New methods and systems for creating, managing, and using different collaboration spaces are advantageous because they provide improved functionality and efficiency, including time savings for users. These and other advantages will be apparent from the disclosure.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “communication event” and its inflected forms includes: (i) a voice communication event, including but not limited to a voice telephone call or session, the event being in a voice media format, or (ii) a visual communication event, the event being in a video media format or an image-based media format, or (iii) a textual communication event, including but not limited to instant messaging, internet relay chat, e-mail, short-message-service, Usenet-like postings, etc., the event being in a text media format, (iv) a status event, including but not limited to presence state change notification, alerting, etc., or (v) any combination of (i), (ii), (iii) and (iv).

The term “communication system” (and “system”) or “communication network” (and “network”) and variations thereof, as used herein, can refer to a collection of communication components capable of one or more of transmission, relay, interconnect, control, or otherwise manipulate information or data from at least one transmitter to at least one receiver. As such, the communication may include a range of systems supporting point-to-point or broadcasting of the information or data. A communication system may refer to the collection individual communication hardware as well as the interconnects associated with and connecting the individual communication hardware. Communication hardware may refer to dedicated communication hardware or may refer a processor coupled with a communication means (i.e., an antenna) and running software capable of using the communication means to send and/or receive a signal within the communication system. Interconnect refers some type of wired or wireless communication link that connects various components, such as communication hardware, within a communication system. A communication network may refer to a specific setup of a communication system with the collection of individual communication hardware and interconnects having some definable network topography. A communication network may include wired and/or wireless network having a pre-set to an ad hoc network structure.

The term “computer-readable medium” refers to any storage and/or transmission medium that participate in providing instructions to a processor for execution. Such a medium is commonly tangible and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “database” is an organized collection of data held in a computer or components of a computer, including storage repositories such as a server and a cloud, and may span many different computers and storage repositories. The data is typically organized to model relevant aspects of reality (for example, the availability of specific types of inventory), in a way that supports processes requiring this information (for example, finding a specified type of inventory). The organization schema or model for the data can, for example, be hierarchical, network, relational, entity-relationship, object, document, XML, entity-attribute-value model, star schema, object-relational, associative, multidimensional, multivalue, semantic, and other database designs. Database types include, for example, active, cloud, data warehouse, deductive, distributed, document-oriented, embedded, end-user, federated, graph, hypertext, hypermedia, in-memory, knowledge base, mobile, operational, parallel, probabilistic, real-time, spatial, temporal, terminology-oriented, and unstructured databases. “Database management systems” (DBMSs) are specially designed applications that interact with the user, other applications, and the database itself to capture and analyze data.

The terms “determine”, “calculate” and “compute,” and variations thereof, are used interchangeably and include any type of methodology, process, mathematical operation or technique.

The term “electronic address” refers to any contactable address, including a telephone number, instant message handle, e-mail address, Universal Resource Locator (“URL”), Universal Resource Identifier (“URI”), Address of Record (“AOR”), electronic alias in a database, like addresses, and combinations thereof.

An “enterprise” refers to a business and/or governmental organization, such as a corporation, partnership, joint venture, agency, military branch, and the like.

A “geographic information system” (GIS) is a system to capture, store, manipulate, analyze, manage, and present all types of geographical data. A GIS can be thought of as a system it digitally makes and “manipulates” spatial areas that may be jurisdictional, purpose, or application-oriented. In a general sense, GIS describes any information system that integrates, stores, edits, analyzes, shares, and displays geographic information for informing decision making.

The terms “instant message” (including “IM”) and “instant messaging” refer to a form of real-time text communication between two or more people, typically based on typed text. Instant messaging can be a communication event. Instant messaging can use Rich Communication Services, which is a communication protocol between mobile-device carriers, and between device and carrier, that enables richer messaging capabilities and transmission of in-call multimedia.

The term “internet search engine” refers to a web search engine designed to search for information on the World Wide Web and FTP servers. The search results are generally presented in a list of results often referred to as SERPS, or “search engine results pages”. The information may consist of web pages, images, information and other types of files. Some search engines also mine data available in databases or open directories. Web search engines work by storing information about many web pages, which they retrieve from the html itself. These pages are retrieved by a Web crawler (sometimes also known as a spider)—an automated Web browser which follows every link on the site. The contents of each page are then analyzed to determine how it should be indexed (for example, words are extracted from the titles, headings, or special fields called meta tags). Data about web pages are stored in an index database for use in later queries. Some search engines, such as Google™, store all or part of the source page (referred to as a cache) as well as information about the web pages, whereas others, such as AltaVista™, store every word of every page they find.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

A “server” is a computational system (e.g., having both software and suitable computer hardware) to respond to requests across a computer network to provide, or assist in providing, a network service. Servers can be run on a dedicated computer, which is also often referred to as “the server”, but many networked computers are capable of hosting servers. In many cases, a computer can provide several services and have several servers running. Servers commonly operate within a client-server architecture, in which servers are computer programs running to serve the requests of other programs, namely the clients. The clients typically connect to the server through the network but may run on the same computer. In the context of Internet Protocol (IP) networking, a server is often a program that operates as a socket listener. An alternative model, the peer-to-peer networking module, enables all computers to act as either a server or client, as needed. Servers often provide essential services across a network, either to private users inside a large organization or to public users via the Internet.

The term “social network” refers to a web-based social network maintained by a social network service. A social network is an online community of people, who share interests and/or activities or who are interested in exploring the interests and activities of others.

The term “workspace(s)” or “collaboration workspace(s)” as used herein refers collaborative software, which can include one or more environments having one or more channels for group communication (e.g., organizing discussions and/or other content). Workspaces may be persistent (e.g., continuing to exist over a prolonged period, whether active or not active (e.g., deactive) or switched back and forth between being active and not active), may provide a context-rich environment, and can provide services within the workspace(s), such as launching external services integrated via APIs. They can be accessed in various ways, including by soft clients and by web browsers. An example of a collaboration workspace is Slack®. Workspaces and collaboration workspaces may also be referred to herein as “spaces.” In addition, spaces may exist within workspaces, and there may be several spaces within a workspace. Spaces may be referred to as channels and/or communication sessions; also, spaces may have multiple channels and/or communication sessions within a space. For example, a workspace may contain several sessions within the workspace, such as a chat element, where the chat element can be thought of as a persistent session because it may last as long as the workspace or longer than the workspace if the workspace is not destroyed when all the members of the workspace leave or deregister (e.g., be removed from the workspace). Thus, spaces and sessions within a workspace may be finite compared to the workspace because they can start and stop within the workspace.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 illustrates a first block diagram of a system in accordance with embodiments of the present disclosure;

FIG. 2 illustrates a second block diagram of a system in accordance with embodiments of the present disclosure;

FIG. 3 illustrates a third block diagram of a system in accordance with embodiments of the present disclosure;

FIG. 4 illustrates a fourth block diagram of a system in accordance with embodiments of the present disclosure; and

FIG. 5 is a logic flow chart according to embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. Various changes may be made in the function and arrangement of elements without departing from the spirit and scope of the disclosure.

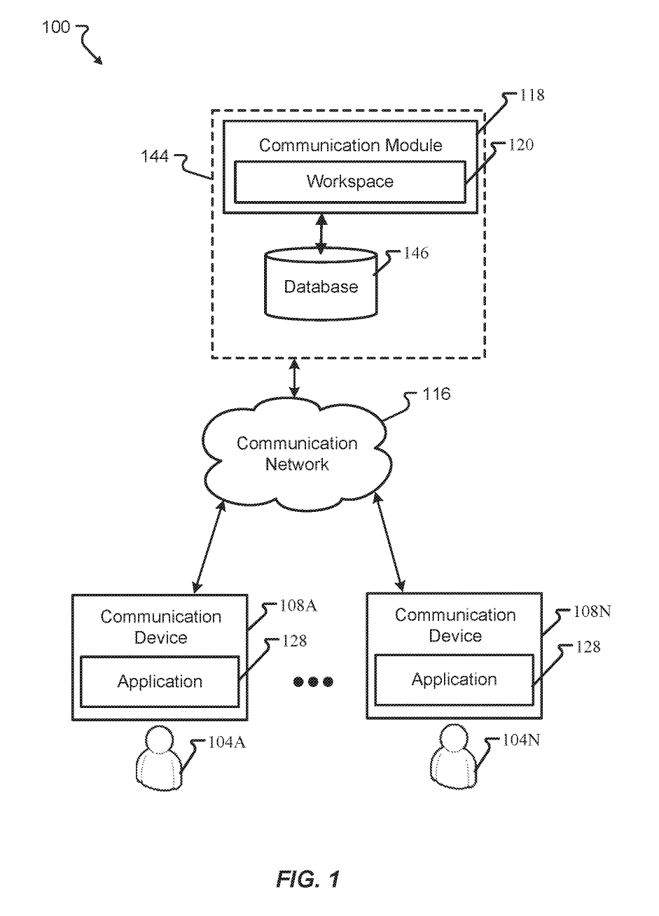

Referring to FIG. 1, a communication system 100 is illustrated in accordance with at least one embodiment of the present disclosure. The communication system 100 may allow users 104A-N to participate in the communication system 100 using respective communication devices 108A-N. As used herein, communication devices include user devices. In accordance with embodiments of the present disclosure, one or more of the users 104A-N may access communication module 116 via communication network 116 to participate in a workspace 120.

The communication network 116 may be packet-switched and/or circuit-switched. An illustrative communication network 116 includes, without limitation, a Wide Area Network (WAN), such as the Internet, a Local Area Network (LAN), a Personal Area Network (PAN), a Public Switched Telephone Network (PSTN), a Plain Old Telephone Service (POTS) network, a cellular communications network, an IP Multimedia Subsystem (IMS) network, a Voice over IP (VoIP) network, a SIP network, or combinations thereof. The Internet is an example of the communication network 116 that constitutes an Internet Protocol (IP) network including many computers, computing networks, and other communication devices located all over the world, which are connected through many telephone systems and other means. In one configuration, the communication network 116 is a public network supporting the TCP/IP suite of protocols. Communications supported by the communication network 116 include real-time, near-real-time, and non-real-time communications. For instance, the communication network 116 may support voice, video, text, web-conferencing, or any combination of media. Moreover, the communication network 116 may comprise a number of different communication media such as coaxial cable, copper cable/wire, fiber-optic cable, antennas for transmitting/receiving wireless messages, and combinations thereof. In addition, it can be appreciated that the communication network 116 need not be limited to any one network type, and instead may be comprised of a number of different networks and/or network types. It should be appreciated that the communication network 116 may be distributed. Although embodiments of the present disclosure will refer to one communication network 116, it should be appreciated that the embodiments claimed herein are not so limited. For instance, more than one communication network 116 may be joined by combinations of servers and networks.

Although multiple user devices 108A-N are shown in FIG. 1, the methods and systems disclosed herein may be used with only one user device. The term “user device” as used herein is not limiting, and may be referred to as a communication device and/or mobile device, and variations thereof. A user device, as used herein, may include any type of device capable of communicating with one or more of another device and/or across a communications network, via a communications protocol, and the like. A user device may comprise any type of known communication equipment or collection of communication equipment. Examples of an illustrative user device may include, but are not limited to, any device that produces sounds, any device with a sound and/or pressure receiver, any device that may be a video endpoint, a camera, a monitor, a sensor, a cellular phone, a smart phone, a telephone, handheld computers, laptops, netbooks, notebook computers, subnotebooks, tablet computers, scanners, portable gaming devices, pagers, GPS modules, portable music players, and other video, sound, and/or pressure receiving devices. A user device does not have to be Internet-enabled and/or network-connected (e.g., it may participate by being proxied through a network connected element. In general, each user device may provide many capabilities to one or more users who desire to use or interact with the communication module 118. However, as discussed herein, a user device does not need to be associated with any user, group, or human user. A user may access a communication module 118 utilizing the communication network 116.

Capabilities enabling the disclosed systems and methods may be provided by one or more user devices through hardware or software installed on the user device, such as application 128. For example, the application 128 can provide a user interface for a user to interact with communication module. The application 128 may be a dedicated representative of the workspace (e.g., a third-party app installed on the device, via which the workspace is accessed and managed, such as Slack® or Avaya Spaces™), or the application 128 may be a standard app that is part of the device but whose information is being connected to the workspace (e.g., a text messaging app that is pre-installed on the mobile device).

In general, each user device 108A-N may provide many capabilities to one or more users 104A-N who desire to interact with the communication module 118. Although each user device 108A-N is depicted as being utilized by one user, one skilled in the art will appreciate that multiple users may share any single user device 108A-N.

In some embodiments, the communication module 118 may reside within a server 144. The server 144 may be a server that is administered by an enterprise associated with the administration of communication device(s) or owning communication device(s), or the server 144 may be an external server that can be administered by a third-party service, meaning that the entity which administers the external server is not the same entity that either owns or administers a user device. In some embodiments, an external server may be administered by the same enterprise that owns or administers a user device. As one particular example, a user device may be provided in an enterprise network and an external server may also be provided in the same enterprise network. As a possible implementation of this scenario, the external server may be configured as an adjunct to an enterprise firewall system, which may be contained in a gateway or Session Border Controller (SBC) which connects the enterprise network to a larger unsecured and untrusted communication network. An example of a messaging server is a unified messaging server that consolidates and manages multiple types, forms, or modalities of messages, such as voice mail, email, short-message-service text message, instant message, video call, and the like.

Although various modules and data structures for the disclosed methods and systems are depicted as residing on the server 144, one skilled in the art can appreciate that one, some, or all of the depicted components of the server 144 may be provided by other software or hardware components. For example, one, some, or all of the depicted components of the server 144 may be provided by logic on a communication device (e.g., the communication device may include logic for the methods and systems disclosed herein so that the methods and systems are performed locally at the communication device). Further, the logic of application 128 can be provided on the server 144 (e.g., the server 144 may include logic for the methods and systems disclosed herein so that the methods and systems are performed at the server 144). In embodiments, the server 144 can perform the methods disclosed herein without use of logic on any user devices 108A-N.

In various embodiments, spaces may be external to a service. For example, a conference bridge that is a part of a workspace may be external to the application 128, so that the audio paths are external to the application 128 because they go directly from the communication devices (e.g., user device 108A-N) to the conference bridge where they are mixed and returned. However, the role of the application 128 in this space (or session) may be to initiate the space (perhaps by invoking an API to an external application) to facilitate the users and/or devices joining the space/session and to potentially capture artifcats of the space/session, including recordings, roster information, etc.

The communication module 118 implements functionality for the methods and systems described herein by interacting with one or more of the user devices 108A-N, application 128, database 146, and/or other sources of information not shown. For example, the communication module 118 can be a collaboration workspace, within which participants (e.g., users and/or devices) can communicate (e.g., interact with messages, post information, launch external services, etc.). The communication module 118 can include one or more workspaces and/or spaces (e.g., workspace 120), within which one or more of the users (e.g., users 104A-N) and/or communication devices (e.g., communication devices 108A-N) can communicate (e.g., place information, interact, organize information, and launch services (including external services integrated via APIs)).

A workspace may be referred to as a space, or a workspace may include many sub-workspaces, or spaces. A space may be referred to as a communication session or a channel, or a space may include various communication sessions and/or channels. A space may also be referred to as a virtual meeting room. Many workspaces may exist and one or more may have various spaces, within which various devices and/or users may collaborate. In various embodiments, settings (such as user and/or device preferences, workspace and space settings, workspace and channel automated content, security settings, etc.) may be configured and changed by any devices, users and/or administrators of the system 100. Settings may be configured to be personalized in any manner (e.g., for a device and/or a user), and may include various types of settings (e.g., identification settings, preferences, security settings, and automated settings, among others). Security settings can include identification information, such as a name, an identification number, a set of information, and biometric records, among other identifying information. For example, settings for different channels may define each channel as a specified workspace for a project, a team, a subject, and a department, among other groups and categories and combinations thereof.

The database 146 may include information pertaining to one or more of the users 104A-N, user devices 108A-N, workspace 120, and communication module 118, among other information. For example, the database 146 can include settings for notifying users of actions that occur related to the workspace 120 (e.g., when new information is posted, the new information is shared with other users and/or devices, etc.).

Application 128 may be executed by one or more user devices (e.g., user devices 108A-N) and may execute all or part of communication module 118 at one or more of the user device(s) 108A-N by accessing data in database 146 using communication module 118. Accordingly, a user may utilize the application 128 to access and/or provide data to the database 146. For example, a user 104A may utilize application 128 executing on user device 108A to set up, participate in, or manage, the workspace 120. Alternatively, or in addition, a device 108A may utilize application 128 executing on device 108A to set up, participate in, or manage the workspace 120. Application 128 is optional, and a user and/or device may connect to, participate in, and manage workspaces and spaces without use of any application.

The communication module 116 may allow access to information in the database 146 and may collect information from other sources for use by the communication module 116. In some instances, data in the database 146 may be accessed utilizing one or more applications, such as application 128, running on one or more user devices, such as user devices 108A-N. Although FIG. 1 depicts a single database 146, it should be appreciated that one or more servers 144 may include one or more communication modules 118 and one or more databases 146. Abilities of a communication module, as described herein, may be performed by a workspace and/or space, and vice versa; thus, communications modules, as described herein, may be workspaces.

The workspace 120 may be executed by the communication module 118 and may be a shared workspace that is persistent. For example, workspace 120 may be set up (e.g., hosted) by one of the users 104A-N for another one or more of the users 104A-N to converse and post information. If the space is persistent, it may continue to exist over a prolonged period of time so that it is not destroyed even if it is inactive (e.g., the space may be quiescent/dormant/not active or have no activity for a period of time; however, the space may reactivate at a later point in time and still maintain its properties (including settings and history) at the time of reactivation). If a space is persistent, it may have many timeframes of inactivity, or being not active, within the lifetime of the space, but may be available to all users and devices at any time for any type of activity, including management, viewing, and participation. In various embodiments, one or more communication devices 108A-N may be a participant of the workspace 120. Also, one or more communication devices 108A-N may not have any link or connection to any of the users 104A-N although it may be any type of device. A device not having any association, link, or connection to a human user may be referred to as an independent device. An independent device may be a participant in a workspace/space. Devices (similar to human users), may participate in workspaces/spaces in any manner, e.g., devices may be a member or non-member of any group and/or team, and may have other properties. For example, prescribed groups may exist, where the prescribed group has an existing membership. Prescribed groups may be created and/or obtained in various ways, such as being imported from other applications or lists. Devices, similar to users, may be includes or excluded (e.g., registered and/or deregistered) from any groups, teams, memberships, etc.

The communication module 118 can enable the system 100 to receive input to create or manage the workspace 120. A user (e.g., user 104A) in a workspace 120 (e.g., displayed to user 104A via application 128 on communication device 108A) can drag and drop or otherwise move and locate from a contacts list another person and/or device to add to the workspace 120. The communication module 118 can receive that input and automatically contact the contact to add them to the workspace 120. Various actions can be performed for users and/or devices, such as dropping them from the workspace 120 and changing their preferences or settings, among other actions. An aspect of the workspace 120 is that it can be persistent. Thus, information about the workspace 120 such as participants (including profile information), settings, content (including documents), session control features such as splits and merges of the session, addition or removal of participants (e.g., users and/or devices), and so forth, can be maintained during and after the workspace 120. Information gathered in preparation for the workspace 120 can be maintained as well. The persistent nature of the workspace 120 can be dynamic as well to capture unanticipated ad hoc events as they arise.

The workspace 120 can identify the participant and mode of communication. A connected user and/or device in a workspace 120 can be displayed on a graphical interface with features that represent a called/calling user and/or device, a disconnected user and/or device, an instant messaging (IM) user and/or device, a device not being associated with any user, a device associated with one or more groups of users, an email user, a user connecting via video conferencing, shared virtual meeting room resources, a sensor or actuator, and so forth. The presentation of the graphical elements, how they are connected and how the user and/or device interacts with the elements can all vary depending on the needs and current active context of the workspace 120. For example, the elements can include text, titles, positions, data about each user and/or device, etc. and the connection metaphor between users and/or devices can also represent information such as the type of connection (phone, video, etc.), the quality of the connection (low-band, high-band, etc.), a hierarchy of how participants are related to the primary user and/or device (friend, owner, associate, acquaintance, trusted user, un-trusted user, etc.), a status of the connection (active, inactive, on-hold, etc.), and so forth. Features for users may be applied for devices and vice versa (e.g., devices may be trusted, un-trusted, etc.).

The system 100 (e.g., via the communication module 118 or workspace 120) can display (or cause to be displayed) a graphical user interface and receive input for manipulating the workspace 120 by interacting with a communications device. For example, the graphical user interface may be displayed on one or more of the devices shown in FIG. 1. In some embodiments, the system 100 integrates the functions of one or more communications device. The system 100 receives input via a physical or on-screen keyboard, mouse, stylus, touch screen, speech command, touchless gestures, and/or single-touch or multi-touch gestures. The system 100 can also receive multi-modal input. Before a workspace is established, the system 100 can show information or a blank home screen, optionally including graphical elements representing communications utilities. The blank screen can include a wallpaper image or other pattern. In some aspects, the system 100 displays a summary or welcome page showing a short summary of workspaces, news, settings, messages, contacts, upcoming calendar events, and/or configuration options. In yet another variation, the system 100 displays a default input mechanism, such as a keyboard or a ten-key numeric pad for dialing telephone numbers.

The workspace can have a persistent component. Activities that occur prior to the workspace, during the workspace, and after the workspace, can persist in the workspace such that they can be retrievable at a later time. For example, participants can post a draft document in preparation for the members using the workspace. Participants could access the document and make changes prior to other workspace activities. In the workspace, a particular group of participants can be involved and the document may change (for instance, co-editing). Content may be presented and services provided. Participants (including users and/or devices) may join or be removed from the workspace. An audio recording and transcription of the conference can be recorded. A sidebar space may occur in which a subset of the participants spend a certain amount of time discussing a side issue and then merge back with the main body of the workspace (e.g., a space may occur with a subset of the participants of the workspace, and then the subset of participants may merge back again with the workspace they were previously participating in). Emails or instant messages may be posted from participants that could not make the workspace. Following collaboration within the workspace, a revised document may be accessed and further revised (e.g., although the workspace becomes inactive at a certain point in time, the document itself may still be accessible within the inactive workspace). The participants may want to reactive the workspace and report on progress after having further modified the document. Workspaces may be managed and accessed in any manner, including repeatedly.

All of the above-mentioned features, and more, can be tracked through the use of a persistent workspace. The system 100, for example, tracks and records participants (e.g., users), documents, activities, settings, session control, and all aspects of the workspaces and/or spaces. The information can be stored and later accessed to reactive or recall the workspace with the various pieces of information remaining in a convenient location. For example, after the workspace concludes, a task item may be for one participant to revise the document that was discussed. The participant can go to the persistent meeting room (e.g., a space within the workspace), update the document such that it (or a copy that is a revised version of it) remains in the room. Other users could then access the document (or both documents) from the same location. The participants can be tracked as well so that the host or other user and/or device could reactivate the meeting (e.g., the space) such that a time can be scheduled, or on an adhoc basis the same group or subgroup can reconvene and carry out collaboration in a follow-on space. All of the important data, transcriptions, recordings, different drafts of the document, etc. can be available for review. Workspaces can have real-time collaboration and non-real-time collaboration.

Workspaces can be established in various ways. For example, default behavior can be established where all participants are invited to a space, and any of the users can drag and drop specific participants, invite members and non-members, and set up prescribed groups that are invited (e.g., a sub-team in a project that meets regularly, a management group, etc.). Also, in some aspects, in order to establish a workspace, a host (e.g., one of the users and/or devices) can drag and drop one or more contacts from a list of contacts into a blank area or onto a virtual conference room hub, dial a number directly via a physical or on-screen keypad, or type in an email address. The list of contacts can also include context based lists based on any kind of context. For example, one context could be previous meetings which were in a virtual meeting room and persistent. The user could search for one of the people in a previous meeting that was held and have the ability to have access to a persistent group of contacts from a previous workspace. The user could then easily reactivate that session (or a different one) since all the users are previously grouped and identified. The graphical interface can enable an easy way to reestablish the workspace.

When a user and/or device initiates a call, instant message, text message, videoconference, reactivates a persistent workspace, or the like with another user and/or device, the system 100 can establish a connection to the other party and display a graphical representation of the workspace with the other party on the screen. The user and/or device can then add additional parties to the workspace in a similar manner. The user and/or device can remove participants from a workspace by dragging them to a trash can icon, clicking an X associated with that participant, or clicking a physical or graphical disconnect button. In one aspect where the workspace is via telephone (perhaps with automated textual transcription of the sounds), the system 100 removes participants from the workspace when each participant hangs up a telephone receiver. As participants leave the workspace, the system 100 removes their icon from the graphical representation of the workspace. In a dynamically persistent meeting room, the system maintains a record of all workspace activity for later retrieval if necessary.

The graphical elements can be not only icons, but can also include images, text, video, animations, sound, caricatures, and/or avatars, among others. Workspace participants (e.g., users and/or devices) can personalize their own graphical elements or feed a live stream of images from a camera or video camera, for example, or these can be personalized or fed by another manner (e.g., by the host or another user and/or device). In addition, the graphical elements can have an associated string of text. The string of text can include a name, a title, a position, a telephone number, email address, a current status, presence information, location, and/or any other available information. The string of text can be separate from but associated with the graphical element. Alternatively, the system 100 can overlay the string of text on top of the graphical element or integrate the text as part of the graphical element. All or part of the text and/or the graphical elements can be hyperlinks to additional information related to the user and/or device associated with the text or graphical elements, such as a blog or micro blog, email address, presence information, and so forth.

The system 100 can include for each icon a graphical sub-element that indicates the communication mode for each participant, such as instant messaging (IM), telephone, and video conference. Thus, a user with multiple devices may have multiple communication modes, and a device may also have multiple communication modes (e.g., a conferencing device may have a voice mode, a video mode, etc.). As a user and/or device changes from one mode to another, the sub-elements can change accordingly. For example, if a user changes from a landline to a cellular phone mid-conference, a telephone icon associated with the user can change to a mobile phone icon. Also, if a device changes from providing video content to providing textual content, the sub-elements can change accordingly.

The graphical elements can also convey information about the workspace by changing type, size, color, border, brightness, position, and so forth. For example, lines can convey relationships between participants. A user and/or device can manually trigger the changes for their own icon or others' icons, or the system 100 can detect change events and change the graphical elements accordingly. Change events can be based on a contacted user and/or device, context, persona, and/or presence of a user and/or device.

For example, as one user and/or device is providing content, the system 100 can enlarge their icon. As another example, the system 100 can track how much each user and/or device in the workspace is participating and move graphical elements up and down based on a total participation time in the workspace. In another example, a user's and/or device's icon is more formal during business hours and more casual before or after business hours.

In another variation, the system 100 can modify the links connecting the graphical elements by changing their thickness, length, color, style, and/or animating the links. These modifications can represent a currently active user and/or device (e.g., based on a presence status), an active workspace, an inactive workspace, a muted workspace, a pending workspace, a connecting workspace, a space within a workspace, a merged workspace, and so forth.

In some aspects, user and/or device preferences can guide the amount and type of information conveyed by the graphical elements and the associated text. User and/or device preferences can be drawn from one or more participants' preferences. Preferences can also be established related to the persistent nature of the workspace. For example, the host can maintain a dynamic record of all events or only record and make persistent the final state such as the final version of shared documents and the final listing of participants. Settings can turn on and off the persistent features. In one case, the host can turn on a persistent characteristic for a split workspace and all documents associated with the split workspace. If that split workspace then is merged back with another workspace, then the persistent characteristic can end and only the split workspace is persistent.

In addition, the present disclosure provides various integration options between spaces. The system 100 may allow for different settings or properties between different spaces while enabling interactions between the different spaces. In various embodiments, the system 100 can federate services and users to integrate information between spaces. For example, contents from one communication workspace can be copied to other workspaces. Workspaces, or portions thereof, can be duplicated, merged, tracked, or otherwise manipulated. In various embodiments, the federation of spaces can allow audio, video, chat sessions, and presence to be established between multiple spaces. This federation can occur regardless of whether the spaces are from a same vendor or different vendors, and also does not require a new space (e.g., a combined space) to be created (e.g., it may be done on a per-session basis with existing space(s)). These embodiments can provide new and improved interoperability between multiple spaces.

Various actions that may be performed by the system 100 or components of the system 100 include the aggregation of various users and/or devices (or some or all of their information) from one or more spaces to create a combined set of users and/or devices (or some or all of their information). Thus, some or all users and/or devices from two different spaces can be combined into other spaces. Policies, or portions of policies, may be applied from one or more space (together with any additional policies or policy changes) to determine user and/or device privileges and settings. Content, or portions of content, from one or more space may be aggregated to create a combined set of content, and/or to relay content between the spaces; this may be done without storing the aggregate, and the policies may be applied to the content as described herein. Aggregating users and/or device and/or content can be done in any manner, and using the features disclosed herein. For example, the users and/or device and/or content can be identified by keywords, by another user/device, and by other identification information, such as associated geographical information or associated timestamp information. Users, devices, and spaces may have some unique properties even if other properties are inherited from some source. The flow of information between more or more spaces may be automated or manually supported within the system 100.

The flow of information may be automated in any manner, such as by using bots (e.g., an application that runs automated tasks/scripts), for example. Applications (including bots) from one or more space may be accessed from other spaces. Bots, similar to devices, may be members of spaces, and various criteria may be used to determine how bots are used, such as using artificial intelligence to decide what bots to invite or exclude to a space. In various aspects, bots can have the same functions and properties as users and devices, as described herein. Bots participating in a collaboration space can have equivalent and/or different rights and capabilities when compared to users and/or devices. Artificial intelligence (including bots) may be used to identify people, devices, and/or content (among other information) to bring such information into a channel automatically.

When any new space is created, it may be created using elements of one or more existing spaces, and elements of different spaces may be presented within a new space (including users, devices, services, etc.). For example, contents and media from different spaces can be enabled to be rendered and managed within a new space. An aggregate set of services can be created in the new space, including third party integrations and bots. Various criteria may be defined and assigned for how elements of other spaces may get into a new space; such criteria may include, but is not limited to, user and/or device specific views, security models, geography, membership in different organizations/groups by users and/or devices, etc. Spaces may integrate information using a GIS. In addition, customization and third-party services may be used to help determine policy and implementation of the new space.

In the system 100, workspaces and spaces may be arranged in any manner. For example, one or more spaces may be represented or duplicated within one or more other spaces, and various content within a space (e.g., one or more channels) may be represented from one or more spaces inside another one or more spaces). Also, as discussed herein, the channel(s) may be federated so that their content or specific classifications of content are automatically posted into one or more spaces. For example, if contractors are working with other users, content (or classifications of content or other information) needed by the contractors may be federated into new spaces created for use by the contractors. Tags for the content may also be represented and/or federated within one or more spaces in order to indicate how information or spaces are shared.

As some illustrative example, federating might mean that a user who wants to see their channel related to project X phase 1 and another channel related to project X phase 2 aggregated can have the channels aggregated in a same channel. Federating may also mean that a user who wants all projects that their department is working on aggregated can have channels for all of the projects aggregated in a same channel. Different options may be employed, as discussed herein. For example, the information (e.g., the projects, phases, etc.) can be color coded to distinguish them. Information having a specific content may be fed (and/or aggregated) into a same channel (e.g., if a corporate patent attorney wants all content with the tag #patent fed into a common channel for the patent team). Also, a user could have a channel for external participants (such as suppliers, managers, and others) be treated as a feed into a channel that is internal to the user that has more proprietary information or additional features. Spaces may be partitioned based on various criteria, e.g., based on media or interaction modalities. In some aspects, all real time interactions can be handled in one (or more) spaces while all persistent interactions are handled in a different space (or spaces) (for instance, when documents are managed in one cloud but communications are managed in another).

Other options for using spaces can include cross-posting in order to allow improved ease of movement back and forth between spaces (context can switch automatically between spaces). Information and/or spaces may be managed or connected to ephemeral data (e.g., to tag content with a best before date, a timer, etc.) and this may be used to manage compliance or privacy. Spaces may include one or more policy layers that can filter what is stored, permitted to be posted, etc. (including encrypted information having key access for private communications or managing need to know (e.g. messages that only US citizens can read)). Other uses related to temporal limitations include the ability to create ad hoc or single use channels on the fly (so called “burner” channels). “To do” actions may be integrated into spaces, or to members of a space (e.g., actions may be integrated using third party tools such as Trello® or Todoist®).

The system 100 may enact (or account for) different settings or properties between different spaces while enabling interactions between the different spaces. For example, networks used by the system 100 may have differences in service level agreements (SLAs) that may be applied on a space-by-space basis (e.g., a network that a non-real-time space uses may require a different SLA than that for a real-time space). In various embodiments for asynchronous communication, bit errors or up time may not be important; however, it may be very important in other embodiments, such as for voice and video. This can vary between spaces (e.g., one space may have its transactions recorded and the other space may not, or one space may be regulated (for instance, concerning voice data) and the other space may not be regulated).

In various embodiments, a device, group of devices, or a combination of users and devices can become members of a collaboration space, where the collaboration space facilitates both real-time collaboration (e.g., video calls, voice calls, conference calls, web sessions, chat sessions, etc.) and persistent/non-real-time collaboration (e.g., document sharing, note keeping, to-do lists, etc.). Devices can be invited to the collaboration space the same way that a user is invited to a collaboration space and may join the collaboration space (e.g., to add content, consume content, engage in real-time collaboration, etc.) depending upon the way in which the device as invited. For example, in some embodiments, members (e.g., devices and/or users) from one channel may be added to a different channel. If this occurs, the added members may have different properties for the different channel than previous members of the different channel. Thus, previous members of the different channel may be given the impression that the added members are proxy members. Similarly, added services may have different properties for the different channel than previous services of the different channel when services of one channel are made available (e.g., posted or added) to a different channel. Thus, members of the different channel may be given the impression that the services are proxy services. In further embodiments, the members of the different channel may not see any difference between the added members/services and the previously existing members/services.

The devices participating in the collaboration space can have equivalent and/or different rights and capabilities when compared to users. Thus, devices can be considered (e.g., recognized as) different entities from the users. In some cases, devices might take on rights and features similar to users. For example, devices can join a collaboration space, have presence status, produce and consume content, post information, send/receive messages, make voice/video/content calls to and from the space, etc. The devices can integrate with the content in the space using existing APIs or can be associated with apps that are already integrated via APIs. The devices can have relationships with people in the space. These relationships can be similar to or different than relationships between users in the space.

In some aspects, devices may be different than users. For example, users can make decisions for themselves as to when they will participate in a collaboration (e.g., view the space, add content, consume content, etc.) whereas a device may not normally be capable of making this type of decision on its own. As an example, endpoints can be added to a space manually (e.g. provisioning) or automatically by virtue of being associated with users who may be members of a space. Presence and other status information for a device may be represented (e.g., graphically displayed) in the space in addition to representing any presence/status information for a user with which the device is associated. Of course, a device does not need to be associated with any user and a device may have its own presence and other status information, among other information. Multiple devices can be associated with a user, multiple users with a device, and devices can be communal so not associated with any particular users.

A device can integrate other members of the space into how they implement unified communications services. For instance, a device may provide distinctive ringing for members of a space who call one another, as well as provide customized name display (such as indicating which space participants are using group services. Devices can participate inside and outside of the space simultaneously or alternate over time. Further, various services can be implemented from devices to a workspace. For example, intercom services and push to talk/video can be implemented from a device to a space and these media services can be translated to text or other formats in the space.

Another aspect may be to facilitate device authentication prior to allowing a device to access a collaboration space. Such authentication may be similar to or different than the way that users are authenticated. There are a variety of potential authentications and this description is not limiting. Potential authentications for a device may include: requiring invitation by a group member (e.g., Joe is a member of a group and he decides to invite his phone to the group), automating the authentication (e.g., Joe's phone is invited when Joe is invited), authenticating by geography (e.g., Joe's team has a space so his meeting room, and by inference the equipment therein, gets invited), provisioning by IT (e.g., every employee has an recording service invited to their channel and it records all audio calls for compliance checking), etc. Some authentication methods can use a list of authorized or invited devices and can compare a device identification against the list prior to allowing the device to access the collaboration space. The authentication method can also use other comparisons, such as comparing device identification information with user identification information (e.g., by using a reference to the user information).

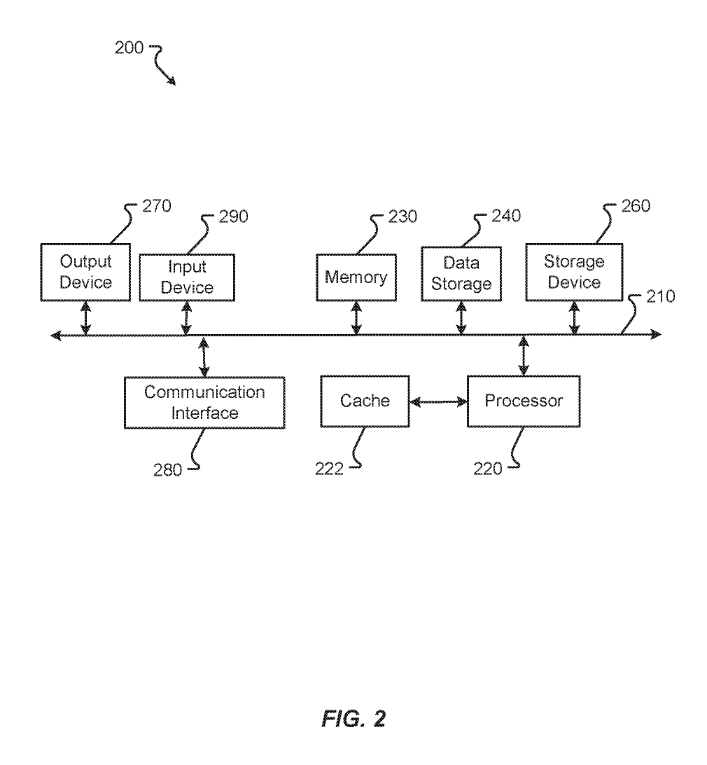

Referring to FIG. 2, a communication system 200 is illustrated in accordance with at least one embodiment of the present disclosure. The illustrative system 200 includes a processor 220 and a system bus 210 that couples various system components including the memory 230 to the processor 220. The system 200 can include a cache 222 of high speed memory connected directly with, in close proximity to, or integrated as part of the processor 220. The system 200 can copy data from the memory 230 to the cache 222 for quick access by the processor 120. The processor 120 can use the various components of system 200 to implement the workspaces described herein.

The system bus 210 may be any of several types of bus structures including a memory bus or memory controller, a peripheral bus, and a local bus using any of a variety of bus architectures. A basic input/output (BIOS) stored in memory 230 or the like, may provide the basic routine that helps to transfer information between elements within the system 200. The storage device 260 is connected to the system bus 210 by a drive interface. The drives and the associated computer readable storage media provide nonvolatile storage of computer readable instructions, data structures, program modules and other data for the computing device 200.

To enable user interaction with the computing device 200, an input device 290 represents any number of input mechanisms, such as a microphone for speech, a touch-sensitive screen for gesture or graphical input, keyboard, mouse, motion input, speech and so forth. An output device 270 can also be one or more of a number of output mechanisms known to those of skill in the art. If the device includes a graphical display which also receives touch sensitive input, the input device 290 and the output device 270 can be essentially the same element or have a similar display. In some instances, multimodal systems enable a user to provide multiple types of input to communicate with the system 200. The communications interface 280 generally governs and manages the user input and system output. Of course, the system 200 is merely illustrative, and other software, hardware, and/or firmware configurations may be used in the method and systems described herein.

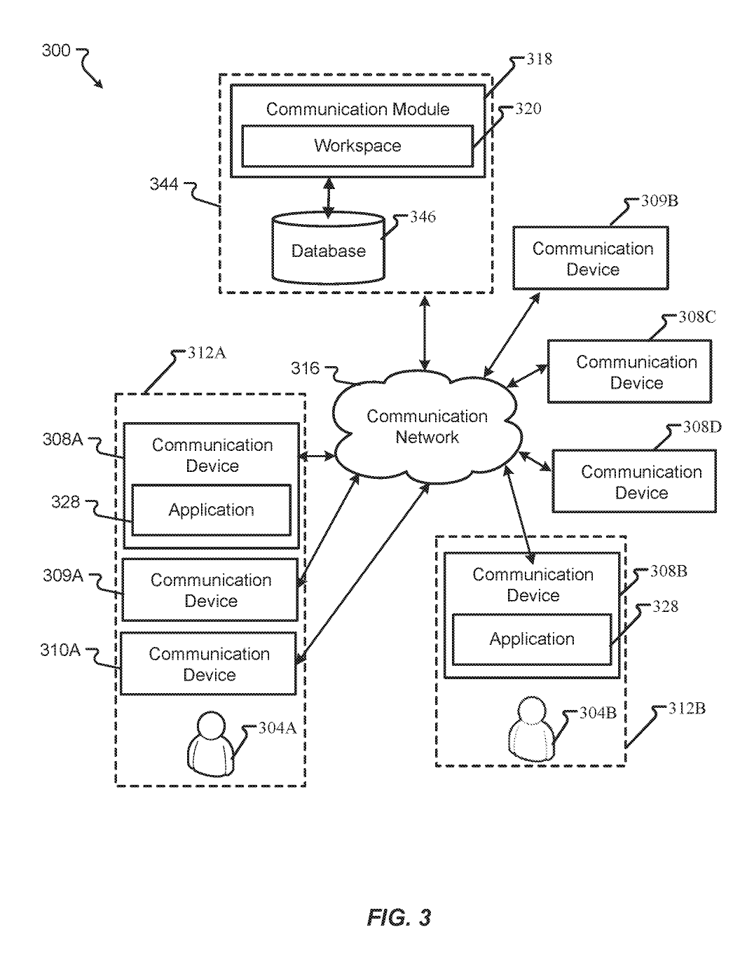

Referring to FIG. 3, a communication system 300 is illustrated in accordance with at least one embodiment of the present disclosure. Components shown in FIG. 3 may correspond to those shown and described in FIGS. 1 and 2. In FIG. 3, the communication system 300 can allow any of users 304A-N to participate in the communication system 300 using various communication devices. For example, as shown in FIG. 3, user 304A has multiple communication devices 308A, 309A, and 310A, with communication device 308A having application 328 installed on it. Although communication devices 309A and 310A (among others) do not have application 328 installed on them, they may still connect to (and participate in) the workspace 320 along with communications device 308A. Although some devices may use application 328 to interface with workspace 320, other devices do not need to use application 328 to interface with workspace 320. Devices not having application 128 may interface with the workspace 320 in various ways (e.g., the act of powering on the device could be an event that is recognized at a workspace by generating state information or presence information into the workspace). The communication devices may be any type of communication device (e.g., 308A may be a mobile phone, 309A may be a desktop computer, and 310A may be a laptop computer).

In FIG. 3, communication devices 308A, 309A, and 310A are located in a first location 312A with user 304A; however a user's devices do not need to be in a same location as a user (as is the case with user 304B) and devices do not need to be associated with a user in any manner (as is the case with communication devices 308C and 308D). User 304B is in a second location 312B and has a communication device 308A also in the second location 312B, as well as a communication device 309B that is not at location 312B.

Communication device 308C is not associated with any user. Devices that are not associated with any user may interact with the workspace 320 without any user interaction, or various users may use the device to interact with the workspace 320. Thus, the communication system 300 can allow devices that are not associated with any user, or that do not have any user present, to participate in a workspace 320. Being “not associated” can include a meaning of one or more of not being linked to any user, not being controlled by any user, not being registered to any user, not being used by any user, and not being owned by any user.

In some embodiments, in FIG. 3, users 304A and 304B can be participating in workspace 320, which is a persistent and real-time collaboration space, using application 328 on communication devices 308A and 308B, respectively, to view and interact with the workspace 320. User 304A is sitting at location 312A and also has communication devices 309A and 310A present at location 312A, and communication devices 309A and 310A are participating in workspace 320 as well. User A 304A is using communication device 309A to record audio of workspace 320, and using communication device 310A to review document changes being made to documents posted in workspace 320 while users 304A and 304B are participating. User 304B does not have any other device at her location 312B, other than communication device 308B. However, user 304B maintains control of communication device 309B at an undisclosed location that is also participating in the workspace 320. Communication device 309B monitors the workspace 320 for content specified by user 304B, and records the specified content when it occurs.

Communication device 308C is not associated with any user and is participating in workspace 320 by feeding a live video stream to the workspace 320. The live video stream is a publicly available video stream controlled by a government entity. Communication device 308D is not associated with any user and is participating in (e.g., is a member of) workspace 320. Communication device 308D is a sensor, e.g., a room occupancy sensor. In the workspace 320, the presence status of communication device 308D changes depending on whether communication device 308D detects whether the room is occupied or not. The information from communication device 308D determines whether a physical space (such as a room) is invited into a session with the virtual space/workspace).

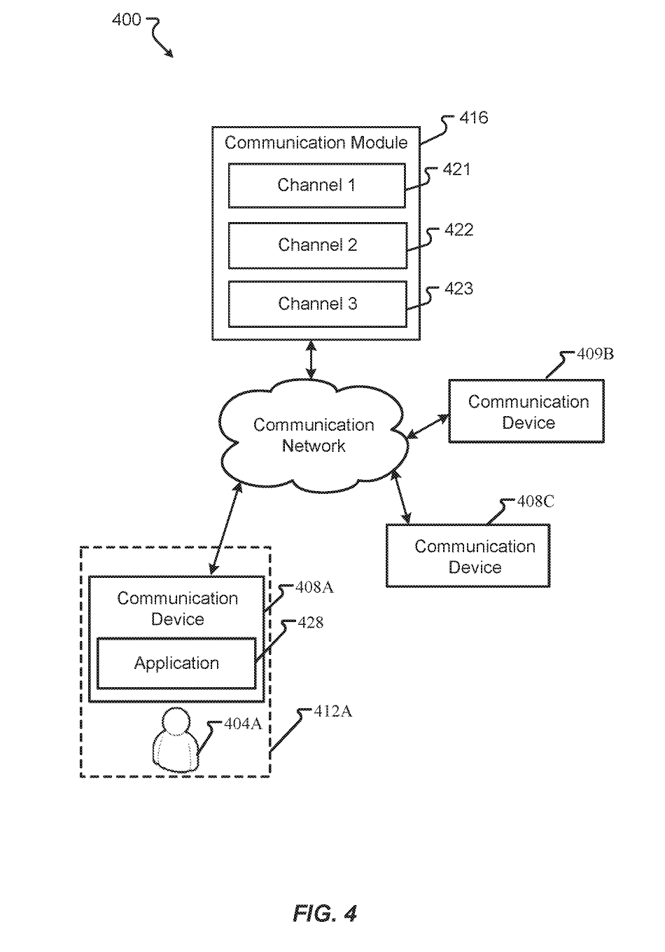

Referring to FIG. 4, a communication system 400 is illustrated in accordance with at least one embodiment of the present disclosure. Components shown in FIG. 4 may correspond to those shown and described in FIGS. 1, 2, and 3. In FIG. 4, the communication system 400 has a communication module 416 that includes various channels. The various channels may be various workspaces, or spaces within a workspace where the workspace is the communication module 416. allows a user 404A to participate in the communication system 400 using communication device 408A via application 428 at location 412A. In some embodiments, in FIG. 4, user 404A is a member of communication module 416, together with communication devices 409B and 408C, and communication module 416 manages several channels that are each a separate, persistent, and real-time collaboration space, including channel 1 421, channel 2 422, and channel 3 423. User 404A is participating in channel 1 421 with communication device 409B. Also, communication device 409B is participating in channel 2 422 with communication device 408C.

In various embodiments, channel 1 421 and channel 2 422 exist in communication module 416 prior to channel 3 423. While user 404A is participating in channel 1 421 with communication device 409B and communication device 409B is participating in channel 2 422 with communication device 408C, a pre-set setting is triggered by the time of day. The pre-set setting (not shown) is automated to create a new channel for communication devices 409B and 408C to post information to, beginning at the pre-set time of day. Thus, at the pre-set time of day, channel 3 423 is created and communication devices 409B and 408C are automatically added to the channel as participating members. In various embodiments, when members (e.g., devices and/or users) from one channel are added to a different channels, previous members of the different channel may be given the impression that the added members are proxy members. Similarly, when services of one channel are made available (e.g., posted or added) to a different channel, members of the different channel may be given the impression that the services are proxy services. In further embodiments, the members of the different channel may not see any difference between the added members/services and the previously existing members/services. When the pre-set setting creates channel 3 423, it adds communication device 409B with its privileges and settings from channel 1 421, and adds communication device 408C with its privileges and settings from channel 2 422. The pre-set setting also, at the time of creating channel 3 423, automatically posts content containing a specific keyword into channel 3 423. In this manner, communication devices 409B and 408C begin participating in channel 3 423 while user 404A is participating in channel 1 421 with communication device 409B and communication device 409B is participating in channel 2 422 with communication device 408C.

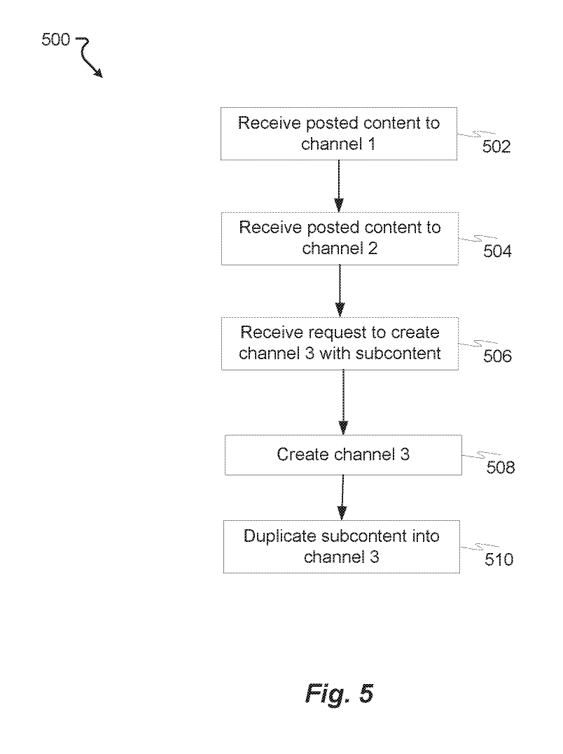

Referring to FIG. 5, a method 500 is illustrated in accordance with at least one embodiment of the present disclosure. The steps shown in FIG. 5 may correspond to components shown and described in FIG. 4. In FIG. 5, the method begins when a workspace receives posted content to channel 1 at step 502. For example, user 404A is participating in channel 1 421 with communication device 409B and posts several links to various pages of a website. Communication device 409B is also participating in channel 1, and can view the links. In step 504, the workspace receives posted content to channel 2. Continuing with using the components of FIG. 4 as an example, communication device 409B is participating in channel 2 422 with communication device 408C. Communication device 409B has an IM conversation in channel 2 422 with communication device 408C.

At step 506, the workspace receives a request to create channel 3, with channel 3 containing subcontent. This request may be made by an administrative user, and the request for the subcontent may be to have any content from channel 1 421 and channel 2 422 that contains the word “Friday” to be posted in channel 3 423. Thus, at step 508, the workspace creates channel 3 423, and at step 510, the workspace duplicates the specified subcontent into channel 3. Once step 510 is complete, channel 3 423 is created and contains some of the links to various pages of a website from channel 1 421 (the ones that contain the word “Friday”) and also portions of the IM conversation from channel 2 422 (also that contain the word “Friday”). Channel 3 423 has settings and participants as specified by the settings of the workspace.

In alternative embodiments, instead of creating a new channel (e.g., Channel 3 423), the information is relayed between different channels. Thus, for example, any subcontent that contains the word “Friday” from channel 1 421 may be posted to channel 2 422, or vice versa. Also, any subcontent that contains the word “Friday” from channel 1 421 and/or channel 2 422 may be posted to the other channel (e.g., the subcontent that contains the word “Friday” from channel 1 421 may be posted to channel 2 422, and the subcontent that contains the word “Friday” from channel 2 422 may be posted to channel 1 421). Of course, based on various settings, the duplication and/or posting of content and subcontent may occur in any manner (such as being automated) including at any timing.

The exemplary systems and methods of this disclosure have been described in relation to a distributed processing network. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital communications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a communications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development locations that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system, comprising:
a first collaboration space having a first set of members,
wherein a device that is not associated with any user is one member within the first set of members of the first collaboration space.

2. The system of claim 1, further comprising:
a second collaboration space, wherein at least one piece of information is federated automatically from the first collaboration space to the second collaboration space.

3. The system of claim 2,
wherein the at least one piece of information is a network resource accessed via an application programming interface (API).

4. The system of claim 2,
wherein the second collaboration space has a second set of members, wherein a subset of members from the first set of members is added to the second collaboration space as added members, and wherein the added members are identified to the second set of members as proxy members.

5. The system of claim 2,
wherein the first collaboration space has a first service, wherein the second collaboration space has a second set of members, wherein the first service is added to the second collaboration space as an added service, and wherein the added service is identified to the second set of members as a proxy service.

6. The system of claim 1, further comprising:
a second collaboration space; and
a third collaboration space;
wherein the third collaboration space is created after the first collaboration space and the second collaboration space,
wherein a first property from the first collaboration space and a second property from the second collaboration space is aggregated into the third collaboration space; and
wherein existence of the third collaboration space is conditioned upon existence of at least one of the first collaboration space and the second collaboration space.

7. The system of claim 6, further comprising:
a second set of members of a second collaboration space; and
a third set of members of a third collaboration space, wherein the third set of members comprises at least some members from each of the first set of members and the second set of members, and wherein the third set of members collaborate within the third collaboration space.

8. The system of claim 6,
wherein the first collaboration space, the second collaboration space, and the third collaboration space each comprise a persistent and context-rich environment.

9. The system of claim 6,
wherein the first property is at least one policy and wherein the second property is a different policy, and wherein a conflict between the at least one policy and the different policy is resolved using an automated arbitration process.

10. The system of claim 6,
wherein the first property is a first element of content,
wherein the second property is a second element of content, and
wherein the first and the second element of content are presented in the third collaboration space.

11. A method, comprising:
establishing a first collaboration space having a first set of members,
wherein a device that is not associated with any user is one member within the first set of members of the first collaboration space.

12. The method of claim 11, further comprising:
establishing a second collaboration space, and
federating at least one piece of information is automatically from the first collaboration space to the second collaboration space.

13. The method of claim 12,
wherein the at least one piece of information is a network resource accessed via an application programming interface (API).

14. The system of claim 12,
wherein the second collaboration space has a second set of members, and further comprising adding a subset of members from the first set of members is to the second collaboration space as added members, wherein the added members are identified to the second set of members as proxy members.

15. The method of claim 12,
wherein the first collaboration space has a first service, wherein the second collaboration space has a second set of members, and further comprising adding the first service is to the second collaboration space as an added service, wherein the added service is identified to the second set of members as a proxy service.

16. The method of claim 11, further comprising:
establishing a second collaboration space; and
establishing a third collaboration space;
wherein the third collaboration space is established after the first collaboration space and the second collaboration space,
wherein a first property from the first collaboration space and a second property from the second collaboration space is aggregated into the third collaboration space; and
wherein existence of the third collaboration space is conditioned upon existence of at least one of the first collaboration space and the second collaboration space.

17. The method of claim 16, further comprising:
a second set of members of a second collaboration space; and
a third set of members of a third collaboration space, wherein the third set of members comprises at least some members from each of the first set of members and the second set of members, and wherein the third set of members collaborate within the third collaboration space.

18. The method of claim 16,
wherein the first collaboration space, the second collaboration space, and the third collaboration space each comprise a persistent and context-rich environment.

19. The method of claim 16,
wherein the first property is at least one policy and wherein the second property is a different policy, and wherein a conflict between the at least one policy and the different policy is resolved using an automated arbitration process.

20. The method of claim 16,
wherein the first property is a first element of content,
wherein the second property is a second element of content, and
wherein the first and the second element of content are presented in the third collaboration space.
